(19) United States
(12) Patent Application Publication
(10) Pub. No.: US 2016/0044875 A1
(43) Pub. Date: Feb. 18, 2016

(54) ENVIRONENMETALLY CONTROLLED PLANT PROTECTIVE APPARATUS

(71) Applicants: David Scott Nutter, Dayton, MD (US); Chad Nutter, West Yarmouth, MA (US)

(72) Inventors: David Scott Nutter, Dayton, MD (US); Chad Nutter, West Yarmouth, MA (US)

(21) Appl. No.: 14/829,235

(22) Filed: Aug. 18, 2015

Related U.S. Application Data
(60) Provisional application No. 62/038,418, filed on Aug. 18, 2014.

(51) Int. Cl. A01G 13/04; A01G 27/00

(52) U.S. Cl. CPC A01G 13/04; A01G 27/006

(57) ABSTRACT

A protective environmentally controlled enclosure for sub-tropical & tropical plants in grown non-tropical zones. The enclosure provides a thermal and humidity controlled environment for outdoor plants during cold or arid conditions. The environment includes a solar panel that provides warming in the winter, married with a PWM charge controller, battery for power storage and heating element for steam or heat generation. A hydration reservoir is provided at the bottom of the enclosure to store water.

### CROSS-REFERENCE TO RELATED APPLICATION

This application claims the benefit of priority of U.S. provisional application No. 62/038,418, filed Aug. 18, 2014, the contents of which are herein incorporated by reference.

### BACKGROUND OF THE INVENTION

The present invention relates to climate controlled environments for growing plants and, more particularly, to enclosures for providing a thermal and humidity protected environment for plants.

Many environments are not conducive to year-long sustainment of tropical and sub-tropical plants planted in, for example, a homeowner's garden. Seasonal changes, such as cold weather or extended arid low humidity conditions in many regions are too harsh for many tropical and sub-tropical plants. For homeowners, or horticulturalists in these regions, they will typically have to dig up plants that they may grow during suitable growing seasons and transplant them indoors when the seasons change (Palm trees, banana trees, hibiscus trees, and many other tropical/sub tropical trees/shrubs). Since marked seasonal changes are often difficult to predict, even with advances in meteorological sciences, the plants may be at risk if their transplantation is delayed. An un-forecasted early or late frost may kill or seriously damage the plants. Transplantation, even if timely, is a cumbersome activity and can risk damage to the plants. Moreover, the transplantation must be done twice a year. Once to remove the plants in the fall and a second to install the plants in the spring.

As can be seen, there is a need for a removable protective apparatus for tropical and sub-tropical plants that creates and sustains an artificial environment sealed off to the ground to regulate temperature and climate, while conserving/trapping humidity and moisture within the enclosure.

### SUMMARY OF THE INVENTION

In one aspect of the present invention, an apparatus for protecting an outdoor plant is disclosed. The apparatus includes a base having a collapsible support frame and a transparent material such as Ludvig Svensson solar ultra-woven material covering the support frame. The support frame has a base member for sealing engagement with a ground surface, and the base containing the plant in an enclosed environment therein, At least one solar panel is operatively connected to a charging station for charging a battery source, said solar panel attached to an outer surface of said transparent material. The battery source is operatively connected to a heating element within the dome. A hydration system having a hydration reservoir is contained within said base. In other embodiments of the invention, a hydration collector external to the base is connected via a tube to the hydration reservoir. The hydration system may further include a valve regulating the flow of water into the hydration reservoir. In another aspect of the invention, the top is substantially dome shaped, with a square pvc base. In certain embodiments the base member further comprises a channel defined in an upper surface of the base member and the channel defines said hydration reservoir.

In a preferred embodiment of the invention the heating element is disposed to heat a volume of water to provide a source of heat & humidity in the contained environment. Preferably the heating element heats the water to about 200 degrees Fahrenheit.

In one embodiment of the invention, a tube will join the top of the dome/apparatus to the plant base, so that water may be funneled to the plant base for ease of watering. It also may have an electrical plug in cord connected to the heating element in case of long periods of rain/cloudiness where the solar panels will not be able to collect sufficient sunlight.

In another aspect of the present invention, an apparatus for protecting an outdoor plant will include a base having a collapsible support frame (such as PVC conduit) and a transparent material covering the support frame (such as ludvig svensson solar ultra woven material, or another greenhouse covering) to define an nclosure for containing the plant. A hydration system including a hydration reservoir, contained within the base, a hydration collector external to the base, and a tube connecting the hydration collector with the hydration reservoir.

At least one solar panel may be provided and operatively connected to a charging station for charging a battery source. The battery source is operatively connected to a heating element contained within the base.

These and other features, aspects and advantages of the present invention will become better understood with reference to the following drawings, description and claims.

### BRIEF DESCRIPTION OF THE DRAWINGS

FIG. 1: is a perspective view of an embodiment of the plant protective apparatus of the present invention.

FIG. 2: is a perspective view of an embodiment with a square or circular base and dome shaped top.

FIG. 3: is a detail perspective view of the solar panels.

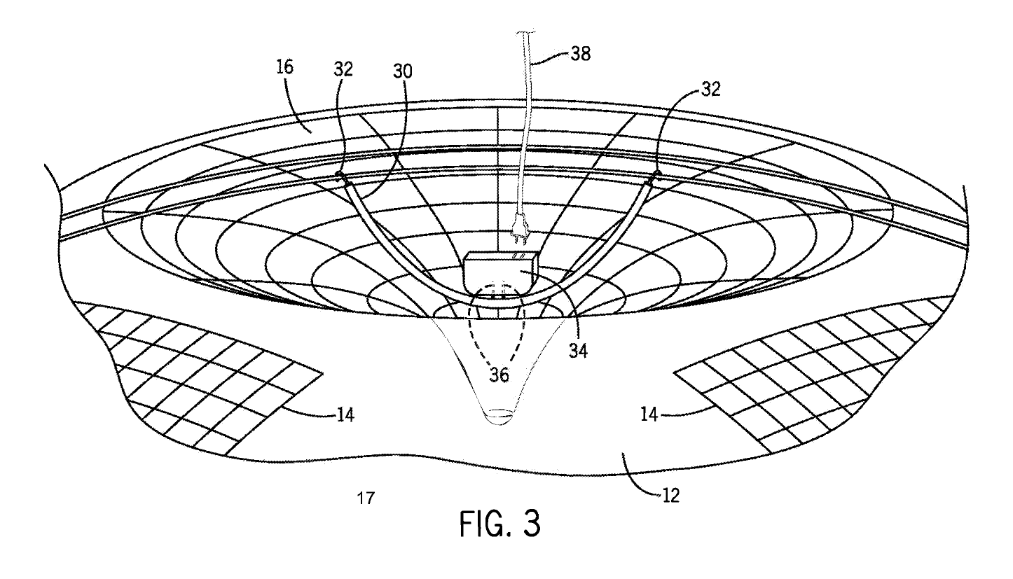

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a controlled environment in which to grow plants, and more particularly, a climate controlled environment adapted to suit sub-tropical and tropical. The apparatus of the present invention provides a controlled environment for the sustainment of sub-tropical and tropical plants, such as shrubs, small trees and the like, that may remain out doors during the fall, winter, and spring months in non-tropical regions.

The apparatus allows sub-tropical/tropical plants/trees to be grown and protected from the harsh winter/fall environments of non-tropical zones, without having to dig up the plants and storing them inside. This invention will enable growers of all sorts and plant/tree lovers to affordably keep almost any specimen tree/shrub safe from things like frost crack, snow blight, breakage under snow weight which can lead to disease/pest exposure and death due to very cold environments. Without Horti-Dome, people in northern latitudes wouldn't be able to affordably and easily expand the diversity of their landscape.

The apparatus creates an artificial environment, mostly sealed off to the ground surrounding a plant, to regulate temperature and climate, while conserving/trapping humidity and moisture in the artificial environment.

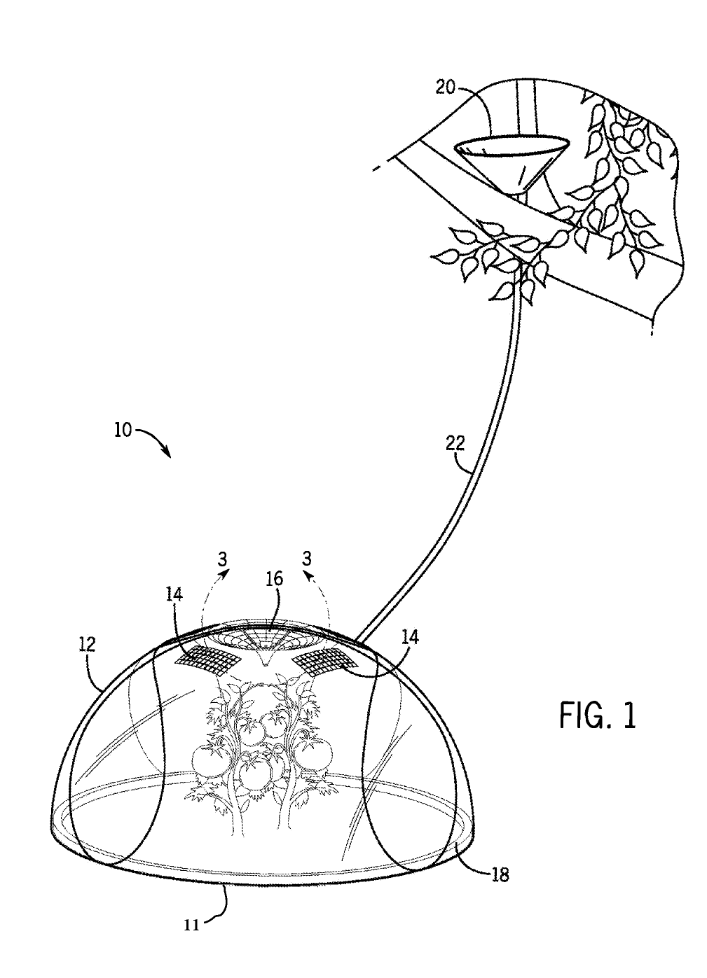

As best seen in reference to FIG. 1, the winter horti-dome plant growth apparatus 10 comprises a base 12. According to certain embodiments of the invention, the base 12 may be as a collapsible tent like structure, more preferably being shaped like a dome 12. The base 12 could be made in any number of dimensions, such as 3×3, 6×6 and 9×9 foot so as to accommodate a variety of tropical and sub-tropical plants, such as small to large size shrubs and small trees. The outer surface of the dome 12 should comprise a flexible transparent greenhouse material. This material would be efficient at trapping heat and protecting the plant from fall/winter conditions and provide an enclosed protected environmentally controlled environment within the base enclosure 12.

In a certain preferred embodiment, the dome's structure is made out of 0.5-1.25″ regular PVC piping connected by side outlet elbow joints and couplings. The frame is square shaped at the bottom, with 2 arching poles extending from opposed corners with a connection/joining at the domes' apex. The outer skin of the dome 12 will be made of greenhouse material such as Ludvig Svensson's solar ultra-woven material, and will be draped over the frame and staked in at 12-24 points at ground level depending on dome size.

The thin film may be fitted to all side edges of the base 12. In the embodiment depicted, the structure for the base 12, may comprise a base member 11, which may be fabricated of plastic, rubber, metal or other resilient material. The base member 11 facilitates providing a seal between the periphery of the dome 12 and a ground surface in which the plants may growing. More preferably, the base ring 11 will have sufficient resiliency so that it conforms to irregularities in the ground surface and provide a suitable seal to contain the controlled environment within the dome 12. The base ring 11, may have a channel 18 defined therein, which provides a hydration reservoir for the apparatus. Alternatively, a containment vessel within the dome 12 may provide a hydration reservoir for retaining a source of water within the apparatus.

The base 12 may be secured to the ground surface by a plurality of ground piercing stakes that engage with the base ring 11, or alternatively a plurality of loops extending from the base ring or thin film. Ideally, the stakes will retain the base 12 so as to withstand heavy winds, such as up to 70 miles per hour.

The base 12 may alternatively include one or more structural members 13, so as to provide shape and support to the transparent film and define the controlled environment within the dome 12. The structural members 13, may include a resilient, flexible wire, formed in a semi serpentine manner that permits the dome 12 to be folded when not in use. Alternatively, the structural members 13 may be elongate flexible rods that may be arched to support the film in the desired shape. Alternatively, PVC tubing may be joined to form a structure of suitable shape to enclose the plant or plants to be protected within the base 12.

The base member 12 may also include at least one solar panel 14, operatively connected to charge a battery and controlled by a charging station 34. The battery provides power to a heating element 35, which may be positioned under a water reservoir 18 so as to elevate the temperature of the water contained in the reservoir 18, preferably to to about 200 degrees Fahrenheit. The elevated temperature of the water provides a source of steam, while not boiling the water. The steam provides a source of heat and humidity which are retained within the base 12 in order to simulate a tropical environment.

The charging station 34 may comprise a pulse width modulator (PWM) and include a logic circuit with high amperage transistors and thermistors/thermal couplers for the temperature sensing/regulating and a high amperage transistor to communicate between charge controller and the heating pad. The thermostat and temperature sensor system constantly monitors the temperature of the environment within the dome 12, turning the heating element on and off when needed to maintain a determined set temperature. For exceptionally cold environments, the charging station 34, may further include a receptacle for receiving electricity via an extension cord 38 connected to a source of alternating current and appropriate conversion to be utilized for charging the battery and/or operating the heating element.

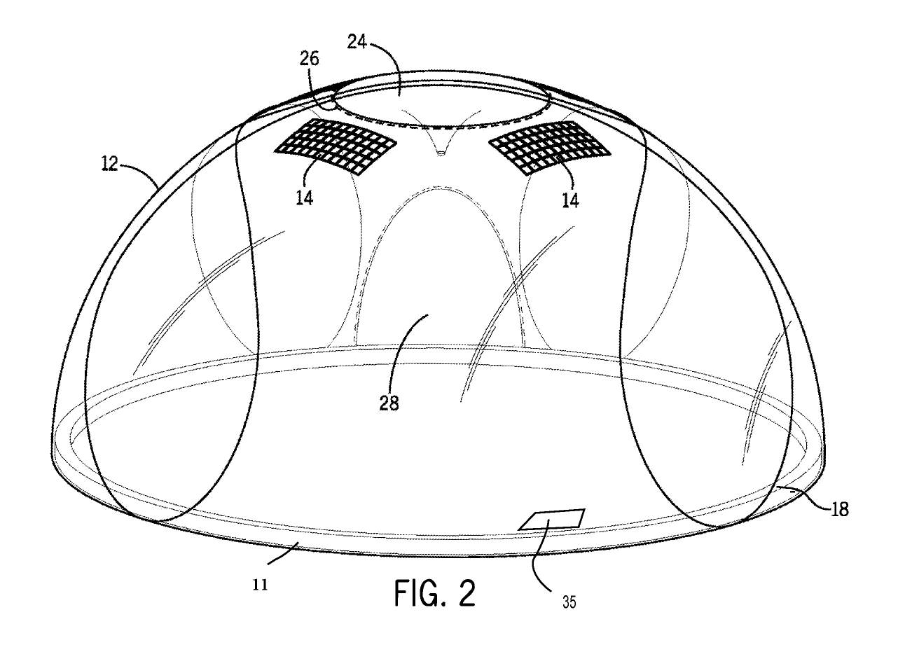

As seen in reference to FIG. 2, the base member 12 may further comprise a removable hood 24, which is connected to the base member 12 via a fastener 26, such as a zipper, hook and pile fabric, or press joined beads, and the like.

In some embodiments of the invention, a filament or tube (not shown) may extend from a bottom end of the conical surface 17 to communicate the condensation so as to replenish the hydration reservoir 18.

In a preferred embodiment of the invention, the solar panel 14 is connected via wires to a PWM (pulse width modulation) charge controller 34 that further connects via contacts 36 to a deep cycle battery or other power storage unit (not shown) that connects to the heating element contained within the base 12. The battery will store energy collected by the solar panels 14 for night time heat release generated by the heating element. The PWM charge controller 34 will ensure the solar panels 14 do not overcharge the battery/power storage unit.

Finally, as seen in reference back to FIG. 1, the apparatus 10 may further include a hydration system. The hydration system may include a water collector 20, such as a funnel for collecting rainwater or other precipitation. The water collector 20 is connected via a tube 20 with a hydration reservoir 18 contained within the base 12. As previously indicated, the hydration reservoir 18 may be a channel defined in the base ring. The water collector 20 may be hung in a non-visible part of other hearty the trees in the vicinity of the protected plants or it may be suspended from any surrounding structure to catch extra water for days lacking humidity, transferring it down to the water reservoir 18 for storage/slow release or manual release within protected environment of the base 12. A valve (not shown) may control the flow rate of water from the collector 20 to the water reservoir 18. The water collector 20 may supply water to a plurality of water reservoirs 18 within a plurality of base enclosures 12.

As seen in reference to FIG. 2, the enclosure may further comprise an access door 28 that is selectively openable via a slide fastener, such as a zipper, Velcro, via hook and pile fabric, or the like. The access door 28 permits the horticulturalist a portal through which to access the plant or the environment within the enclosure for maintenance, care of the plant and other purposes, while permitting the remainder of the environment to be contained around the plant.

To use the device, a user may simply install Horti-Dome 12 over a rare ornamental maple specimens, or favorite grouping of tropical shrubs such as hibiscus shrubs, or over your banana/Palm trees to prevent having to dig them up and move them inside for the winter. Nurseries could have these for their most special and sensitive plantings, or for extra needed greenhouse space. The apparatus of the present invention could also be used to slow grow hardy vegetables in the winter or extend the growing season of things like tomatoes, peppers, cucumber, etc.

It should be understood, of course, that the foregoing relates to exemplary embodiments of the invention and that modifications may be made without departing from the spirit and scope of the invention as set forth in the following claims.

What is claimed is:

1. An apparatus for protecting an outdoor plant comprising:
a base having a collapsible support frame and a transparent material covering said support frame; said support frame comprising a base member for sealing engagement with a ground surface, and said base containing said plant in an enclosed environment therein;
at least one solar panel operatively connected to a charging station for charging a battery source, said solar panel attached to a surface of said transparent material, and said battery source operatively connected to a heating element contained within said base; and
a hydration system having a hydration reservoir contained within said base, a hydration collector external to said base, and a tube connecting said hydration collector with said hydration reservoir.

2. The apparatus of claim 1, wherein said base is substantially square or circular shaped.

3. The apparatus of claim 2, wherein said base ring further comprises a channel defined in an upper surface of said base ring and said channel defines said hydration reservoir.

4. The apparatus of claim 1, wherein said heating element is disposed to heat a volume of water contained in said hydration reservoir.

5. The apparatus of claim 4, wherein said heating element heats said water to about 200 degrees Fahrenheit to produce the steam needed to heat the environment.

6. The apparatus of claim 6, further comprising:
a removable hood selectively disposed over said solar sink.

7. The apparatus of claim 6, wherein said solar sink defines a downwardly extending surface on the interior of the enclosure, wherein said surface collects condensation formed on said surface.

8. The apparatus of claim 8, further comprising a filament extending between said solar sink and said hydration reservoir, wherein said filament communicates said condensation to said hydration reservoir.

9. The apparatus of claim 9, further comprising a tube extending between said solar sink and said hydration reservoir, wherein said tube communicates said condensation to said hydration reservoir.

10. The apparatus of claim 1, wherein hydration system further comprises a valve regulating the flow of water into the hydration reservoir.

11. An apparatus for protecting an outdoor plant comprising:
a base having a collapsible support frame and a transparent material covering said support frame to define an enclosure containing said plant;
a hydration system having a hydration reservoir contained within said base, a hydration collector external to said base, and a tube connecting said hydration collector with said hydration reservoir; and
a heating element contained within said base.

12. The apparatus of claim 11, further comprising:
at least one solar panel operatively connected to a charging station for charging a battery source, said battery source operatively connected to the heating element.

13. The apparatus of claim 11, wherein said base member further comprises a channel defined in an upper surface of said base member and said channel defines said hydration reservoir.

14. The apparatus of claim 12, wherein said heating element is disposed to heat a volume of water contained in said hydration reservoir.

15. The apparatus of claim 12, wherein said heating element heats said water to about 200 degrees Fahrenheit.

15. The apparatus of claim 11, further comprising:
a solar sink disposed in a top surface of said enclosure, said solar sink receiving solar radiation; and wherein said solar sink defines a downwardly projecting surface on the interior of the enclosure, wherein said surface collects condensation formed on said surface.

16. The apparatus of claim 14, further comprising a filament extending between said solar sink and said hydration reservoir, wherein said filament communicates said condensation to said hydration reservoir.

17. The apparatus of claim 14, further comprising a tube extending between said solar sink and said hydration reservoir, wherein said tube communicates said condensation to said hydration reservoir.

18. The apparatus of claim 11 further comprising a battery charge controller.

19. The apparatus of claim 18, wherein said charge controller comprises a pulse width modulator.
